(19) United States
(12) Patent Application Publication
(10) Pub. No.: US 2026/0244129 A1
(43) Pub. Date: Aug. 20, 2026

(54) FIXING DEVICE AND IMAGE FORMING APPARATUS

(71) Applicant: KYOCERA Document Solutions Inc., Osaka (JP)

(72) Inventor: Takuya KAWASUMI, Osaka (JP)

(73) Assignee: KYOCERA Document Solutions Inc., Osaka (JP)

(21) Appl. No.: 19/533,294

(22) Filed: Feb. 9, 2026

(30) Foreign Application Priority Data
Feb. 14, 2025 (JP) 2025-022498

(51) Int. Cl. G03G 15/20

(52) U.S. Cl. CPC G03G 15/2017; G03G 15/2064; G03G 2215/2035

(57) ABSTRACT

A fixing device includes a fixing member, a pressure member, a pair of holding members, and a pair of side plates. The pair of side plates are arranged in parallel to the conveying direction, and have recesses to which the pair of holding members are mounted along a mounting direction intersecting the conveying direction. Each of the pair of holding members includes a shaft support portion, a regulating surface, and an upstream groove and a downstream groove. The regulating surface regulates movement of the fixing member in the axial direction. The pair of holding members are configured such that, when the pair of holding members are mounted in the recesses such that the side plates are fitted into the upstream groove and the downstream groove, a distance between the regulating surfaces is widened from the upstream side to the downstream side in the conveying direction.

### INCORPORATION BY REFERENCE

This application is based on and claims the benefit of priority from Japanese patent application No.2025-022498 February 14, 2025, which is incorporated by reference in its entirety.

### BACKGROUND

The present disclosure relates to a fixing device which fixes a toner image on a sheet, and an image forming apparatus including the fixing device.

In the fixing device using a flexible fixing belt, both ends of the fixing belt are held by a pair of holding members. The pair of holding members are supported by a pair of side plates of a fixing housing. Each holding member is provided with a regulating surface for regulating movement of the fixing belt in the axial direction (the direction intersecting the conveying direction). When the fixing belt travels normally, no force is generated to move the fixing belt in the axial direction, and both end surfaces of the fixing belt do not abut on the regulating surfaces.

However, if there is a difference in rotational speed between both the end portions of the fixing belt, the fixing belt is inclined with respect to the conveying direction so that the end portion having the higher rotational speed is located on the downstream side of the conveying direction. Then, a force is generated that moves the fixing belt in the axial direction toward the end portion having the higher rotational speed. If the fixing belt is moved in the axial direction in such an inclined posture, the fixing belt may break when the downstream end surface of the fixing belt abuts against the regulating surface.

Therefore, in the fixing device, the pair of side plates for supporting the pair of holding members holding both the end portions of the fixing belt may be provided such that the distance between the side plates increases from the upstream side to the downstream side in the conveying direction. If the pair of holding members are supported by such a pair of side plates, the distance between the regulating surfaces of both the holding members is wider on the downstream side than on the upstream side. Thus, even if the fixing belt is moved in the axial direction, the downstream end surface of the fixing belt is hardly brought into contact with the regulating surface, so that the end portion of the fixing belt can be prevented from being damaged.

### SUMMARY

A fixing device according to the present disclosure includes a fixing member, a pressure member, a pair of holding members, and a pair of side plates. The fixing member is flexible, and formed in a cylindrical shape and rotatable along a circumferential direction. The pressure member is rotatable around an axis, and forms a pressure region between the fixing member and the pressure member to heat and pressurize a toner on a sheet while conveying the sheet in a predetermined conveying direction. The pair of holding members hold both end portions of the fixing member in an axial direction. The pair of side plates are arranged in parallel to the conveying direction, and have recesses to which the pair of holding members are mounted along a mounting direction intersecting the conveying direction. Each of the pair of holding members includes a shaft support portion, a regulating surface, and an upstream groove and a downstream groove. The shaft support portion guides one end portion of the fixing member in the axial direction along the circumferential direction. The regulating surface regulates movement of the fixing member in the axial direction by contacting with one end surface of the fixing member in the axial direction. The upstream groove and the downstream groove are provided along the mounting direction on the upstream side and the downstream side of the shaft support portion in the conveying direction, and into which the side plates are fitted. The pair of holding members are configured such that, when the pair of holding members are mounted in the recesses such that the side plates are fitted into the upstream groove and the downstream groove, a distance between the regulating surfaces is widened from the upstream side to the downstream side in the conveying direction.

An image forming apparatus according to the present disclosure includes an image forming part which forms a toner image on a sheet, and the fixing device which fixes the toner image formed in the image forming part to the sheet.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a side view schematically showing an internal structure of an image forming apparatus according to one embodiment of the present disclosure.

FIG. 2 is a perspective view showing a fixing device according to the embodiment of the present disclosure.

FIG. 3 is a side view showing a side plate of a fixing housing of the fixing device according to the embodiment of the present disclosure.

FIG. 4 is a cross-sectional view showing a belt assembly and a pressure roller of the fixing device according to the embodiment of the present disclosure.

FIG. 5 is a perspective view showing a holding member of the fixing device according to the embodiment of the present disclosure.

FIG. 6 is a plan view showing the holding member of the fixing device according to the embodiment of the present disclosure.

FIG. 7 is a side view showing the holding member of the fixing device according to the embodiment of the present disclosure, as viewed from an upstream side.

FIG. 8 is a side view showing the holding member of the fixing device according to the embodiment of the present disclosure, as viewed from a downstream side.

FIG. 9 is a plan view showing the holding member attached to the fixing housing in the fixing device according to the embodiment of the present disclosure.

### DETAILED DESCRIPTION

Hereinafter, with reference to the drawings, an image forming apparatus and a fixing device according to one embodiment of the present disclosure will be described.

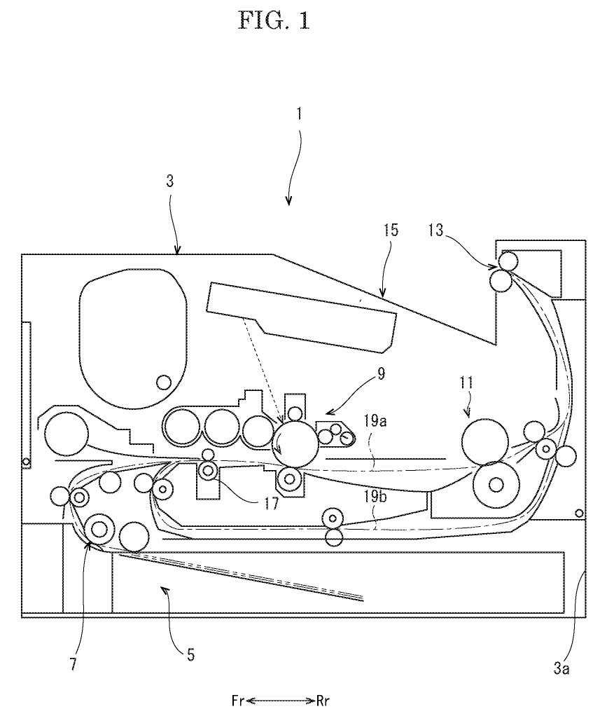

First, with reference to FIG. 1, the image forming apparatus 1 will be described. FIG. 1 is a front view schematically showing the internal structure of the image forming apparatus 1. Reference numerals Fr, Rr, L, R, Up, and Lo attached to the following drawings indicate the front, rear, left, right, upper, and lower, respectively.

An apparatus main body 3 of the image forming apparatus 1 includes a sheet feeding cassette 5 in which a sheet is stored, a sheet feeding device 7 which feeds the sheet from the sheet feeding cassette 5, an image forming part 9 which forms a toner image on the sheet by an electrophotographic method, a fixing device 11 which fixes the toner image to the sheet, a discharge device 13 which discharges the sheet, and a discharge tray 15 on which the discharged sheet is stacked. A pair of registration rollers 17 is disposed between the sheet feeding device 7 and the image forming part 9.

The sheet feeding cassette 5 is accommodated in a cassette storage space 3a provided in the lower portion of the inside of the apparatus main body 3. The sheet feeding device 7 is disposed above the front end of the cassette storage space 3a. The pair of registration rollers 17 is disposed above the sheet feeding device 7. The image forming part 9 is disposed on the rear side of the pair of registration rollers 17. The fixing device 11 is disposed on the rear side of the image forming part 9. The discharge device 13 is disposed above the fixing device 11. The discharge tray 15 is provided on the upper surface of the apparatus main body 3.

Further, a main conveying path 19a and a double-sided conveying path 19b along which the sheet is conveyed are formed in the apparatus main body 3. The main conveying path 19a is formed along a conveying direction X from the sheet feeding device 7 to the discharge device 13 via the image forming part 9 and the fixing device 11. In the following description, the upstream side and the downstream side indicate the upstream side and the downstream side in the conveying direction X. The double-sided conveying path 19b branches from the main conveying path 19a on the downstream side of the fixing device 11 and merges with the main conveying path 19a on the upstream side of the pair of registration rollers 17.

Next, the image forming operation will be briefly described. In the case of single-sided printing, the sheet fed from the sheet feeding cassette 5 by the sheet feeding device 7 is conveyed along the main conveying path 19a, the skew of the sheet is corrected by the pair of registration rollers 17, and the sheet is conveyed to the image forming part 9. In the image forming part 9, the toner image is formed on the sheet. The sheet on which the toner image is formed is conveyed to the fixing device 11 along the main conveying path 19a, and the toner image is fixed to the sheet in the fixing device 11. The sheet on which the toner image is fixed is discharged to the discharge tray 15 by the discharge device 13.

In the case of doble-sided printing, the sheet on which the toner image is fixed to one side of the sheet by the fixing device 11 passes through the fixing device 11 and is switched back to be conveyed to the double-sided conveying path 19b. The sheet is conveyed along the main conveying path 19a via the double-sided conveying path 19b. After the skew of the sheet is corrected by the pair of registration rollers 17, the toner image is formed to the other surface of the sheet by the image forming part 9. The sheet on which the toner image is formed is conveyed to the fixing device 11 along the main conveying path 19a, and the toner image is fixed to the other surface of the sheet in the fixing device 11. The sheet on which the toner image is fixed is conveyed along the main conveying path 19a to the discharge device 13, and discharged to the discharge tray 15 by the discharge device 13.

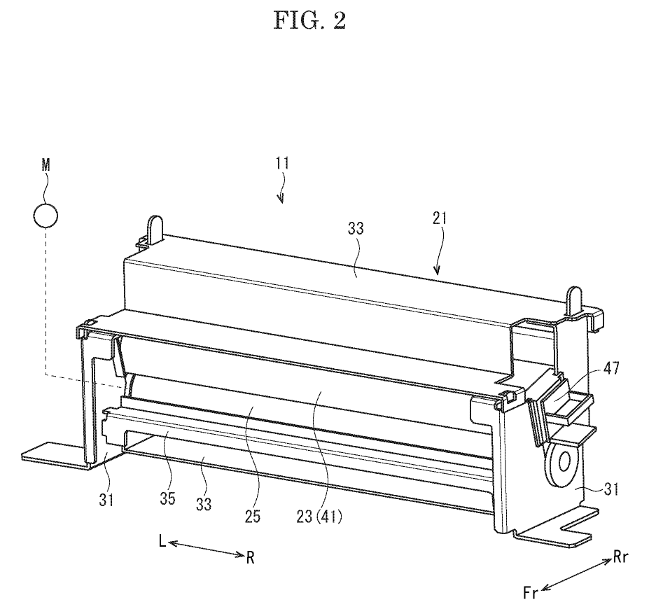

Next, the fixing device 11 will be described with reference to FIG. 2. FIG. 2 is a cross-sectional view showing the internal structure of the fixing device 11. The fixing device 11 includes a fixing housing 21, a belt assembly 23, and a pressure roller 25.

First, the fixing housing 21 will be described. The fixing housing 21 includes left and right side plates 31 facing each other in the left-and-right direction, and upper and lower stays 33 and front and rear stays 35 provided between the left and right side plates 31. The left and right side plates 31 are supported in parallel by the upper and lower stays 33 and the front and rear stays 35. That is, the distance between the left and right side plates 31 is constant in the conveying direction X. The fixing housing 21 is made of sheet metal.

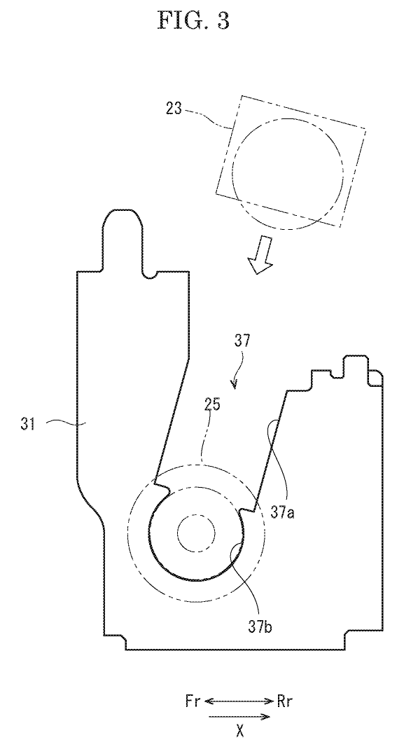

The left and right side plates 31 will be described with reference to FIG. 3. FIG. 3 is a side view showing the left side plate 31. The side plate 31 has a substantially rectangular shape, and has a recess 37 in which the end portions of the belt assembly 23 and the pressure roller 25 are mounted. The recess 37 is slightly inclined downwardly from the upper edge of the side plate 31. The recess 37 has, in order in the depth direction, an upper portion 37a to which the end portion of the belt assembly 23 is mounted and a lower portion 37b to which the end portion of the pressure roller 25 is mounted. The upstream side edge and the downstream side edge of the upper portion 37a are formed in parallel. The belt assembly 23 is mounted to the upper portion 37a along a mounting direction parallel to both the side edges of the upper portion 37a.

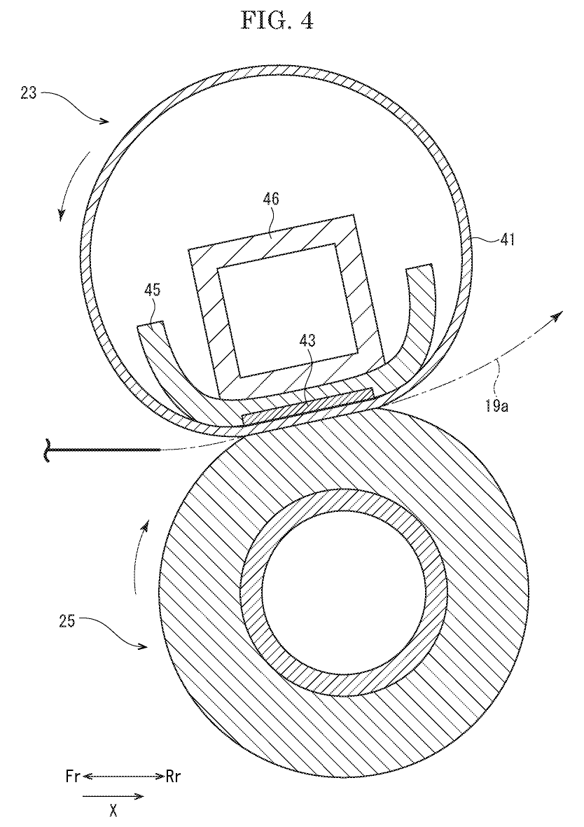

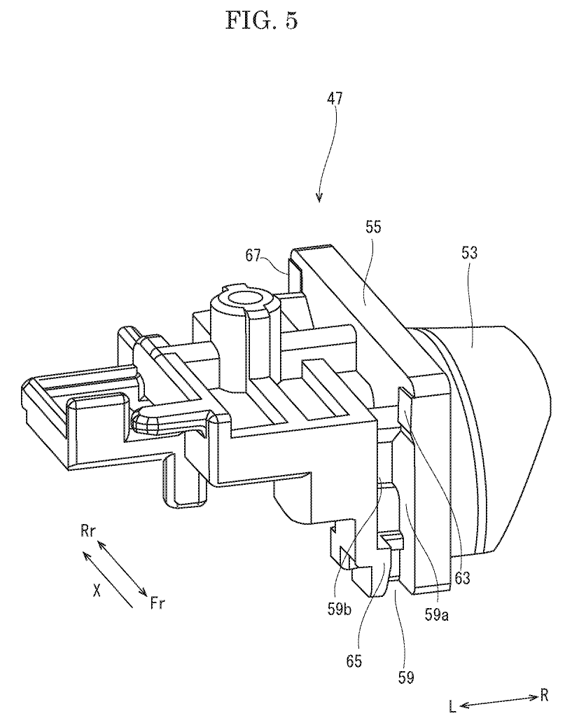

Next, the belt assembly 23 will be described with reference to FIG. 4. FIG. 4 is a cross-sectional view showing the belt assembly 23 and the pressure roller 25. The belt assembly 23 includes a fixing belt 41, a heater 43 which heats the fixing belt 41, a heater holder 45 which holds the heater 43, and right and left holding members 47 (not shown in FIG. 4, see FIG. 5) which holds the heater holder 45.

First, the fixing belt 41 will be described. The fixing belt 41 is formed in a cylindrical shape having a predetermined inner diameter and a width longer than the width of the sheet. The fixing belt 41 is made of flexible material, and includes a base material layer, an elastic layer provided on the outer peripheral surface of the base material layer, and a release layer provided on the outer peripheral surface of the elastic layer. The base material layer is made of resin. The elastic layer is made of silicone rubber or the like. The release layer is formed of a PFA tube or the like.

Next, the heater 43 will be described. The heater 43 is a rectangular planar heater 43. The planar heater 43 includes a base material, a heat insulating layer, a heating resistor layer, and a coat layer. When the heating resistor layer is energized, the heating resistor layer generates heat.

Next, the heater holder 45 will be described. The heater holder 45 is formed in a substantially semi-cylindrical shape along the circumferential direction of the inner circumferential surface of the fixing belt 41, and has a width wider than that of the fixing belt 41. A flat surface is formed on the top of the outer circumferential surface of the heater holder 45. A recess for housing the planar heater 43 is formed on the flat surface. The heater holder 45 is made of heat-resistant resin such as liquid crystal polymer. The heater holder 45 is supported by a stay 46.

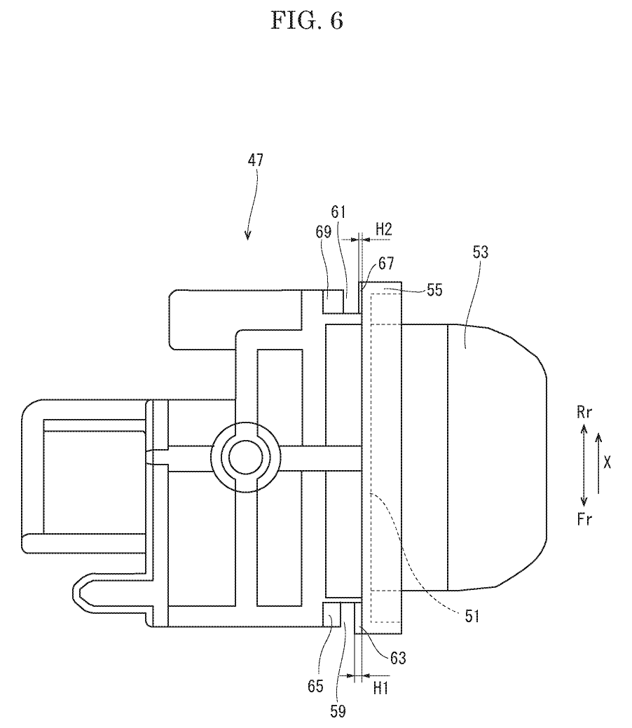

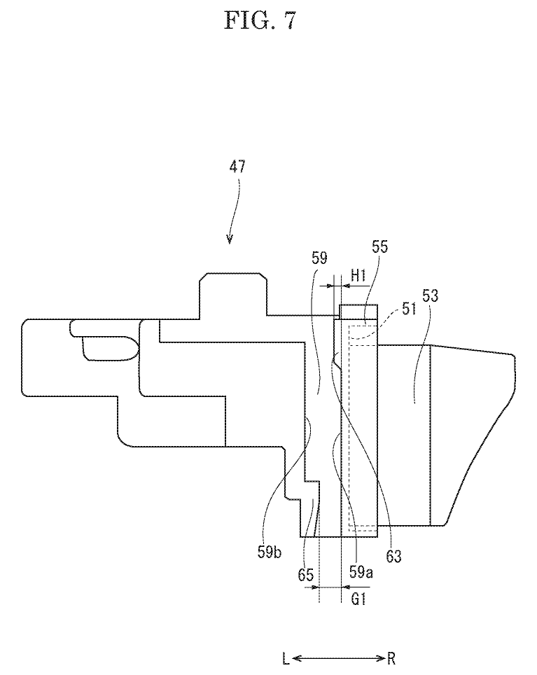

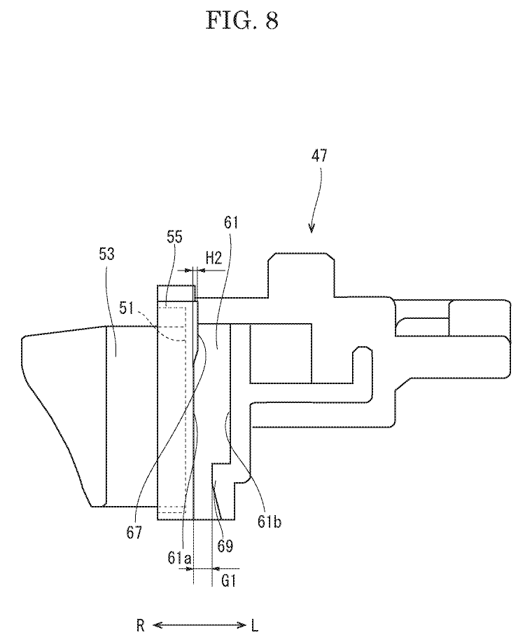

Next, the left and right holding members 47 will be described with reference to FIG. 5 to FIG. 8. FIG. 5 is a perspective view showing the holding member 47, FIG. 6 is a side view showing the holding member 47 viewed from the upstream side, FIG. 7 is a side view showing the holding member 47 viewed from the downstream side, and FIG. 8 is a side view showing the holding member 47. Here, the left holding member 47 will be described. The right holding member 47 has the same function as the left holding member 47. The holding member 47 is made of resin having heat resistance and abrasion resistance.

As shown in FIG. 6, the holding member 47 has a substantially rectangular flat end surface 51. The end surface 51 is an example of the regulating surface which regulates the axial movement of the fixing belt 41 in the present disclosure. Hereinafter, the end surface 51 is referred to as the regulating surface 51. The regulating surface 51 is formed with a substantially 3/4 arcuate opening with the lower side open (not shown). A shaft support portion 53 is erected along the periphery of the opening on the regulating surface 51. The shaft support portion 53 is formed in a substantially cylindrical shape having a substantially C-shaped cross section with the lower side open. The axial direction of the shaft support portion 53 is perpendicular to the regulating surface 51. On the regulating surface 51, an insulating wall 55 is erected along the edge other than the lower edge.

The right and left end portions of the fixing belt 41 are fitted around the shaft support portions 53 of the right and left holding members 47. The shaft support portions 53 hold the fixing belt 41 in a substantially cylindrical shape and guide the fixing belt 41 rotatably along the circumferential direction (the rotational direction).

The holding member 47 has an upstream groove 59 and a downstream groove 61 which are along the upper and-lower direction on the opposite side to the shaft support portion 53 across the regulating surface 51. As shown in FIG. 6, the upstream groove 59 and the downstream groove 61 are aligned in the conveying direction X on the upstream side and the downstream side of the shaft support portion 53, respectively. The opening of the upstream groove 59 and the opening of the downstream groove 61 face opposite directions. That is, the opening of the upstream groove 59 faces the upstream side of the conveying direction X, and the opening of the downstream groove 61 faces the downstream side of the conveying direction X.

As shown in FIG. 7 and FIG. 8, the upstream groove 59 has an inner side surface 59a on the side of the regulating surface 51 and an outer side surface 59b facing the inner side surface 59a, and the downstream groove 61 has an inner side surface 61a on the side of the regulating surface 51 and an outer side surface 61b facing the inner side surface 61a. The inner side surface 59a and the outer side surfaces 59b are parallel, the inner side surface 61a and the outer side surface 61b are parallel. A distance between the inner side surfaces 59a and the outer side surface 59b and a distance between the inner side surface 61a and the outer side surface 61b are wider than the thickness of the side plate 31 of the fixing housing 21.

As shown in FIG. 7, an inner projection 63 is formed on the upper end portion of the inner side surface 59a of the upstream groove 59. The inner projection 63 has a substantially rectangular parallelepiped shape, and its end surface is formed flat and parallel to the regulating surface 51. The lower surface of the inner projection 63 is inclined upward. A height H1 of the inner projection 63 is 0.25 mm, as one example. An outer projection 65 is formed on the lower end portion of the outer side surface 59b of the upstream groove 59. The outer projection 65 also has a substantially rectangular parallelepiped shape, and its end surface is formed flat and parallel to the regulating surface 51. The lower surface of the outer projection 65 is inclined upward. A distance G1 between the end surface of the outer projection 65 and the inner side surface 59a is substantially equal to the thickness of the side plate 31 of the fixing housing 21. A predetermined gap is provided between the end surface of the inner projection 63 and the end surface of the outer projection 65.

As shown in FIG. 8, an inner projection 67 is formed on the upper end portion of the inner side surface 61a of the downstream groove 61. The inner projection 67 has a substantially rectangular parallelepiped shape, and its end surface is formed flat and parallel to the regulating surface 51. The lower surface of the inner projection 67 is inclined upward. A height H2 of the inner projection 67 is 0.05 mm, as one example, which is lower than the height H1 of the inner projection 63 of the upstream groove 59. An outer projection 69 is formed on the lower end portion of the outer side surface 61b of the downstream groove 61. The outer projection 69 also has a substantially rectangular parallelepiped shape, and its end surface is formed flat and parallel to the regulating surface 51. The lower surface of the outer projection 69 is inclined upward. A height of the outer projection 69 is equal to the height of the outer projection 65 of the upstream groove 59. A distance G1 between the end surface of the outer projection 69 and the inner side surface 61a is substantially equal to the thickness of the side plate 31 of the fixing housing 21. A predetermined gap is provided between the end surface of the inner projection 67 and the end surface of the outer projection 69.

Next, the pressure roller 25 will be described with reference to FIG. 4. The pressure roller 25 has a rotational shaft, an elastic layer provided on the outer peripheral surface of the rotational shaft, and a release layer provided on the outer peripheral surface of the elastic layer.

With reference to FIG. 2 and FIG. 3 again, both end portions of the rotational shaft of the pressure roller 25 are supported by the lower portions 37b of the recesses 37 of the left and right side plates 31 of the fixing housing 21. A drive gear (not shown) is fixed to one end of the rotational shaft of the pressure roller 25. The drive gear is connected to a motor M (see FIG. 2) via a gear train (not shown).

The left and right holding members 47 of the belt assembly 23 are mounted to the upper portions 37a of the recesses 37 of the left and right side plates 31 of the fixing housing 21 in the mounting direction. More specifically, the upstream side plate 31 on the upstream side of the recess 37 (referred to as the upstream side plate 31U) and the downstream side plate 31 on the downstream side of the recess 37 (referred to as the downstream side plate 31D) are fitted into the upstream groove 59 and the downstream groove 61 of the holding member 47. The upstream side plate 31U is inserted through the gap between the outer projection 65 and the inner side surface 59a of the upstream groove 59 (see FIG. 7). The downstream side plate 31D is inserted through a gap between the outer projection 69 and the inner side surface 61a of the downstream groove 61 (see FIG. 8). Since the lower surfaces of the outer projections 65, 69 are inclined upward, the upstream side plate 31U and the downstream side plate 31D are guided into the gaps along the lower surfaces. Further, the upstream side plate 31U is inserted through the gap between the inner projection 63 and the outer side surface 59b of the upstream groove 59 (see FIG. 7). The downstream side plate 31D is inserted through the gap between the inner projection 67 and the outer side surface 61b of the downstream groove 61 (see FIG. 8). Since the lower surfaces of the inner projections 63, 67 are also inclined upward, the upstream side plate 31U and the downstream side plate 31D are guided into the gaps along the lower surfaces.

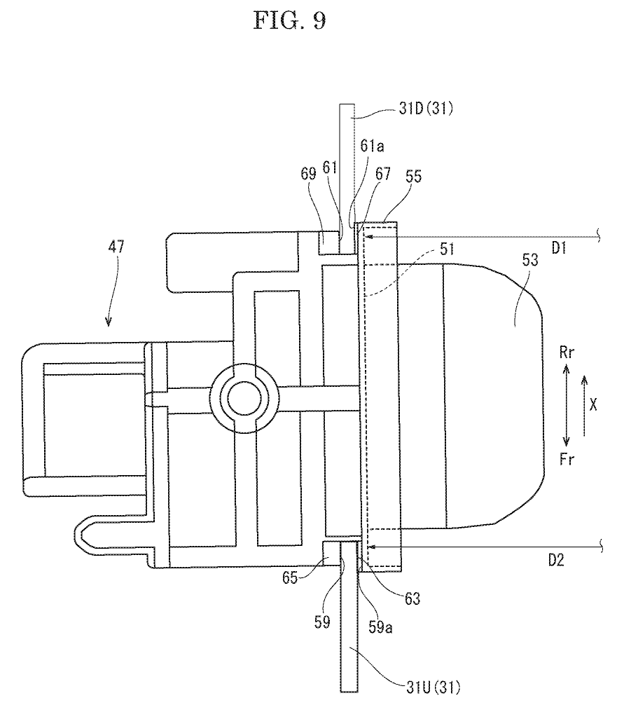

As shown in FIG. 9, when the holding member 47 is completely fitted into the upper portion 37a of the recess 37, the upstream side plate 31U is fixed by being held between the outer projection 65 and the inner side surface 59a of the upstream groove 59, and is pushed outward (in the direction opposite to the regulating surface 51) by the inner projection 63. In other words, the inner projection 63 is pushed inward (toward the regulating surface 51) with respect to the side plate 31. The downstream side plate 31D is fixed by being held between the outer projection 69 and the inner side surface 61a of the downstream groove 61, and is pushed outward by the inner projection 67. In other words, the inner projection 67 is pushed inward with respect to the side plate 31.

As described above, since the height H1 of the inner projection 63 of the upstream groove 59 is higher than the height H2 of the inner projection 67 of the downstream groove 61, the distance by which the inner projection 63 of the upstream groove 59 is pushed inward is longer than the distance by which the inner projection 67 of the downstream groove 61 is pushed inward. As a result, the left and right holding members 47 are mounted on the side plates 31 in a posture in which the regulating surface 51 is inclined outward in the axial direction of the shaft support portion 53 from the upstream side toward the downstream side. That is, as shown in FIG. 9, in the left and right holding members 47, the interval D1 between the regulating surfaces 51 on the downstream side of the shaft support portion 53 is longer than the interval D2 between the regulating surfaces 51 on the upstream side of the shaft support portion 53.

The stay 46 of the belt assembly 23 project through the openings of the left and right holding members 47, and are supported by the left and right side plates 31 of the fixing housing 21. The heater 43 held by the heater holder 45 faces the pressure roller 25 across the fixing belt 41. Thus, a pressure region is formed between the fixing belt 41 and the pressure roller 25.

The fixing operation of the fixing device 11 having the above configuration will be described. When the motor M is driven to rotate the pressure roller 25, the fixing belt 41 follows the pressure roller 25 and rotates in the direction opposite to the rotational direction of the pressure roller 25. The heater 43 is driven to heat the fixing belt 41. When the sheet on which the toner image is formed is conveyed to the pressure region, the toner image is heated and fixed to the sheet.

During the normal fixing operation, both the end surfaces of the fixing belt 41 are not in contact with the regulating surfaces 51 of the left and right holding members 47. However, depending on the dimensional accuracy of the pressure roller 25 and the fixing housing 21 and the positional deviation of the left and right holding members 47, a difference in the rotational speed between the end portions of the fixing belt 41 may occur. In this case, the fixing belt 41 is inclined with respect to the conveying direction X such that the end portion having the higher rotational speed is located on the downstream side of the conveying direction. More specifically, at the end portion having the higher rotational speed, the inner peripheral surface of the fixing belt on the downstream side is guided along the shaft support portion 53, but the inner peripheral surface of the fixing belt on the upstream side is lifted from the shaft support portion 53. Further, a force acts on the fixing belt to move it in the axial direction to the end portion having the higher rotational speed. If the fixing belt 41 moves in the above-described posture and comes into contact with the regulating surface 51, the end portion of the fixing belt 41 may be folded.

As described above, according to the present disclosure, since the interval between the regulating surfaces 51 is widened from the upstream side to the downstream side, even if the fixing belt 41 is moved in the axial direction, the end surface of the fixing belt 41 hardly comes into contact with the regulating surface 51. Therefore, the end portion of the fixing belt 41 can be prevented from being damaged.

The right and left side plates 31 of the fixing housing 21 are disposed parallel to each other along the conveying direction X. Since no twisting force is applied to the right and left side plates 31, the fixing housing 21 can be easily assembled, and the right and left holding members 47 and the pressure roller 25 can be stably supported by the fixing housing 21.

Further, with a simple configuration in which the heights of the inner projections 63 and 67 formed in the upstream groove 59 and the downstream groove 61 of the holding member 47 are changed, the interval between the regulating surfaces 51 of the left and right holding members 47 can be widened from the upstream side to the downstream side.

In the above embodiment, the left and right holding members 47 are mounted on the side plates 31 in the posture inclined outward in the axial direction of the shaft support portion 53, so that the interval D1 between the regulating surfaces 51 on the downstream side of the shaft support portion 53 is made longer than the interval D2 between the regulating surfaces 51 on the upstream side of the shaft support portion 53. However, instead of the right and left holding members 47 being mounted on the side plate 31 in such an inclined posture, the regulating surface 51 may be formed so as to be inclined outward in the axial direction of the shaft support portion 53 from the upstream side toward the downstream side. In this case, the axial direction of the shaft support portion 53 is not orthogonal to the regulating surface 51. In this example, the left and right holding members 47 are mounted on the side plates 31 in a posture in which the shaft support portions 53 are orthogonal to the conveying direction X, and the interval between the regulating surfaces 51 is wider from the upstream side to the downstream side.

Although the disclosure has been described with respect to certain embodiments, the disclosure is not limited to the foregoing embodiments. The above embodiments can be modified by those skilled in the art without departing from the scope and spirit of the disclosure.

What is claimed is:

1. A fixing device comprising:
a flexible fixing member formed in a cylindrical shape and rotatable along a circumferential direction;
a pressure member which is rotatable around an axis, and forms a pressure region between the fixing member and the pressure member to heat and pressurize a toner on a sheet while conveying the sheet in a predetermined conveying direction;
a pair of holding members which hold both end portions of the fixing member in an axial direction; and
a pair of side plates which are arranged in parallel to the conveying direction, and have recesses to which the pair of holding members are mounted along a mounting direction intersecting the conveying direction, wherein
each of the pair of holding members includes:
a shaft support portion which guides one end portion of the fixing member in the axial direction along the circumferential direction;
a regulating surface which regulates movement of the fixing member in the axial direction by contacting with one end surface of the fixing member in the axial direction; and
an upstream groove and a downstream groove which are provided along the mounting direction on the upstream side and the downstream side of the shaft support portion in the conveying direction, and into which the side plates are fitted, and
the pair of holding members are configured such that, when the pair of holding members are mounted in the recesses such that the side plates are fitted into the upstream groove and the downstream groove, a distance between the regulating surfaces is widened from the upstream side to the downstream side in the conveying direction.

2. The fixing device according to claim 1, wherein
the upstream groove has an inner side surface on a side of the regulating surface, and an outer side surface facing the inner side surface with a gap wider than a thickness of the side plate,
the downstream groove has an inner side surface on a side of the regulating surface, and an outer side surface facing the inner side surface with a gap wider than a thickness of the side plate,
an inner projection which abuts on the side plate is formed on the inner side surface of the upstream groove,
an inner projection which abuts on the side plate is formed on the inner side surface of the downstream groove, and
a height of the inner projection of the upstream groove is higher than a height of the inner projection of the downstream groove.

3. The fixing device according to claim 2, wherein
an outer projection which abuts on the side plate is formed on the outer side surface of the upstream groove,
an outer projection which abuts on the side plate is formed on the outer side surface of the downstream groove, and
a height of the outer projection of the upstream groove is the same as a height of the outer projection of the downstream groove.

4. The fixing device according to claim 3, wherein
a gap between the outer projection and the inner side surface of the upstream groove is equal to a thickness of the side plate, and a gap between the outer projection and the inner side surface of the downstream groove is equal to the thickness of the side plate.

5. The fixing device according to claim 3, wherein
the inner projections are formed on upper portion of the inner side surfaces, and the outer projections are formed on lower portions of the outer side surfaces.

6. An image forming apparatus comprising:
an image forming part which forms a toner image on a sheet, and
the fixing device according to claim 1, which fixes the toner image formed in the image forming part to the sheet.
